(19) United States
(12) Patent Application Publication
(10) Pub. No.: US 2014/0147910 A1
(43) Pub. Date: May 29, 2014

(54) METHODS AND SYSTEMS FOR RECOVERING PHOSPHORUS FROM WASTEWATER WITH ENHANCED REMOVAL OF PHOSPHORUS FROM BIOSOLIDS

(71) Applicant: Keith E. Bowers, Seattle, WA (US)

(72) Inventor: Keith E. Bowers, Seattle, WA (US)

(21) Appl. No.: 13/820,038

(22) PCT Filed: Aug. 30, 2011
(86) PCT No.: PCT/US11/49769

§ 371 Date: May 15, 2013

Related U.S. Application Data
(60) Provisional application No. 61/378,287, filed on Aug. 30, 2010.
(60) Provisional application No. 61/378,295, filed on Aug. 30, 2010.

(51) Int. Cl. C01B 25/01

(52) U.S. Cl. CPC C01B 25/01
USPC 435/262; 435/289.1

(57) ABSTRACT

Methods and systems for removal and recovery of phosphorus from wastewater and producing inorganic phosphorus complexes with enhanced removal of phosphorus from biosolids.

### CROSS-REFERENCE TO RELATED APPLICATIONS

This application claims the benefit of U.S. Patent Application No. 61/378,287, filed Aug. 30, 2010, and U.S. Patent Application No. 61/378,295, filed Aug. 30, 2010, each expressly incorporated herein by reference in its entirety.

### BACKGROUND OF THE INVENTION

The presence of dissolved phosphate in industrial effluents and wastewater is a long-standing problem in the art. Phosphorus (referred to herein as “P”) is a non-renewable resource and an important non-substitutable macronutrient, existing in nature as phosphates in various inorganic or organic forms, and ranging from the simple to the very complex in terms of molecular structure. Because P is essential for all biological processes, there is concern that the current demand and exploitation (total annual production is about 20 million tons of P, derived from roughly 140 million tons of rock concentrates) of this non-renewable resource is not sustainable. Nearly all the P used globally is mined from a relatively small number of commercially-exploitable deposits, and it has been estimated that the global economic P reserves may last about 100 years at the current rate of extraction. Therefore, the world's P resources are finite and should be used efficiently and in a sustainable way. Additionally, aside from the non-renewable resource aspect, there is need to improve P management, particularly from the environment protection perspective because, for example, P-enrichment in receiving waters is associated with harmful algae blooms that affect the health and vitality of wetlands and marine environments. Therefore, there is a pronounced need in the art to develop methods for increasing the life expectancy of the world's limited P resources. There is a pronounced need in the art to develop methods for recovery and recycling of P from industrial effluents and wastewater.

Art-recognized P removal technologies applied to wastewater include chemical and biological processes. One chemical technology for P removal and recovery is crystallization of P in the form of struvite (magnesium ammonium phosphate hexahydrate or MgNH₄PO₄.6H₂O). Struvite is crystalline and thus well suited for formation from effluent streams. In addition, as a granular product struvite is more compact than other chemical precipitates, and it performs well as a slow-release fertilizer. Struvite formation requires reaction between three soluble ions in solution, Mg²⁺, NH₄⁺ and PO₄³⁻, to form precipitates with low solubility (struvite has a pKₛₚ of 12.6). Struvite precipitation is controlled by pH, supersaturation, and presence of impurities, such as calcium. High pH (e.g., pH 8.5) and supersaturation of the three ions are favorable to struvite formation.

As part of secondary sewage treatment, primary treated sewage is treated with air or oxygen. In the activated sludge process, microorganisms utilize oxygen to metabolize the incoming waste sewage thereby forming a mixture of microorganisms and sewage (mixed liquor). This mixture is conducted to settling tanks for concentration to provide concentrated activated sludge. A majority of the sludge is returned to the activated sludge process and a separate portion of this sludge (waste activated sludge) is removed from the activated sludge process and conducted to a sludge handling system for further treatment and disposal.

In a typical wastewater treatment process, waste activated sludge is conducted to a solids separation (centrifuge or other thickening apparatus) for thickening, where the liquids are tapped off and returned to the wastewater plant for treatment and the resultant thickened sludge is conducted to an anaerobic digester with other sludge where it remains for a period of time before being conducted to a second solids separation (centrifuge or other dewatering apparatus) for dewatering. The liquid from the solids separation step is further processed and the solids, often referred to as biosolids, are removed from the process stream and disposed of, by for example, incineration, land application, and depositing in a landfill. Excess phosphorus in the biosolids renders these solids more expensive to dispose of.

However, biosolids separated from process streams through solids separation steps can contain significant and useful quantities of phosphorus.

Despite the advances in removing phosphorus from wastewater through the formation and recovery of struvite, a need exists for improved wastewater treatment methods and systems having increased phosphorus removal and recovery efficiencies and increased inorganic phosphorus production. The present invention seeks to fulfill this need and provides further related advantages.

### SUMMARY OF THE INVENTION

In one aspect, the invention provides methods for treating wastewater and producing inorganic phosphorus.

In one embodiment, the invention provides a method for treating wastewater and producing inorganic phosphorus, comprising:

(a) inducing a mixture of microorganisms containing phosphorus and magnesium to release phosphorus and magnesium to provide a treated mixture that includes phosphorus and magnesium;

(b) separating the treated mixture into a phosphorus- and magnesium-rich liquid and a first phosphorus- and magnesium-reduced mixture;

(c) anaerobically treating the first phosphorus- and magnesium-reduced mixture to provide an ammonia-rich, phosphorus- and magnesium-reduced mixture;

(d) combining the phosphorus- and magnesium-rich liquid from step (b) with the ammonia-rich, phosphorus- and magnesium-reduced mixture from step (c) to provide an ammonia-, phosphorus-, and magnesium-containing product; and

(e) conducting the ammonia-, phosphorus-, and magnesium-containing product to an inorganic phosphorus reactor to provide inorganic phosphorus and a phosphorus- and magnesium-containing mixture.

In one embodiment, the method further comprises subjecting the phosphorus- and magnesium-containing mixture to solids separation to provide biosolids and a phosphorus- and magnesium-reduced liquid.

In one embodiment, the method further comprises subjecting the ammonia-, phosphorus-, and magnesium-containing product to solids separation to provide biosolids and an ammonia-, phosphorus-, and magnesium-containing liquid, and conducting the ammonia-, phosphorus-, and magnesium-containing liquid to the inorganic phosphorus reactor.

In another embodiment, the invention provides a method for treating wastewater and producing inorganic phosphorus, comprising:

(a) inducing a mixture of microorganisms containing phosphorus and magnesium to release phosphorus and magnesium to provide a treated mixture that includes phosphorus and magnesium;

(b) separating the treated mixture into a phosphorus- and magnesium-rich liquid and a phosphorus- and magnesium-reduced mixture;

(c) anaerobically treating the phosphorus- and magnesium-reduced mixture to provide an ammonia-rich, phosphorus- and magnesium-reduced mixture;

(d) combining the phosphorus- and magnesium-rich liquid from step (b) with the ammonia-rich, phosphorus- and magnesium-reduced mixture from step (c) to provide an ammonia-, phosphorus-, and magnesium-containing mixture; and

(e) conducting the ammonia-, phosphorus-, and magnesium-containing mixture to an inorganic phosphorus reactor to provide inorganic phosphorus.

In one embodiment, the method further comprises subjecting residual solids-containing liquid from the reactor to solids separation to provide biosolids and a liquid optionally conducted to the process headworks.

In a further embodiment, the invention provides a method for treating wastewater and producing inorganic phosphorus, comprising:

(a) inducing a mixture of microorganisms containing phosphorus and magnesium to release phosphorus and magnesium to provide a treated mixture that includes phosphorus and magnesium;

(b) separating the treated mixture into a phosphorus- and magnesium-rich liquid and a phosphorus- and magnesium-reduced mixture;

(c) anaerobically treating the phosphorus- and magnesium-reduced mixture to provide an ammonia-rich, phosphorus- and magnesium-reduced mixture;

(d) combining the phosphorus- and magnesium-rich liquid from step (b) with the ammonia-rich, phosphorus- and magnesium-reduced mixture from step (c) to provide an ammonia-, phosphorus-, and magnesium-containing mixture;

(e) subjecting the ammonia-, phosphorus-, and magnesium-containing mixture to solids separation to provide an ammonia-, phosphorus-, and magnesium-containing liquid and biosolids; and

(f) conducting the ammonia-, phosphorus-, and magnesium-containing liquid to an inorganic phosphorus reactor to provide inorganic phosphorus.

For the above methods, in certain embodiments, the methods further comprise conducting liquid from the reactor to the process headworks. In certain embodiments, the methods further comprise adjusting the pH of the contents of the inorganic phosphorus reactor. In certain embodiments, the methods further comprise adding magnesium to the contents of the inorganic phosphorus reactor. In certain embodiments, the inorganic phosphorus is a magnesium ammonium phosphate hexahydrate (i.e., struvite).

In another aspect of the invention, systems for treating wastewater and producing inorganic phosphorus are provided.

In one embodiment, the invention provides a system for treating wastewater and producing inorganic phosphorus, comprising:

(a) a first conduit for introducing a material into a first solids separator;

(b) a first solids separator for separating the material into a first liquid and a first mixture;

(c) a digester for anaerobically treating the first mixture to provide a second mixture;

(d) a second conduit intermediate the first solids separator and the digester for conducting the first mixture from the first solids separator to the digester;

(e) an inorganic phosphorus reactor for making inorganic phosphorus;

(f) a third conduit intermediate the digester and the inorganic phosphorus reactor for conducting the second mixture to the inorganic phosphorus reactor;

(g) a fourth conduit intermediate the first solids separator and the inorganic phosphorus reactor for conducting the first liquid to the inorganic phosphorus reactor;

(h) a second solids separator; and

(i) a fifth conduit intermediate the inorganic phosphorus reactor and the second solids separator.

In certain embodiments, the third conduit joins the fourth conduit to combine the first liquid with the second mixture prior to their introduction to the inorganic phosphorus reactor.

In another embodiment, the invention provides a system for treating wastewater and producing inorganic phosphorus, comprising:

(a) a first conduit for introducing a material into a first solids separator;

(b) a first solids separator for separating the material into a first liquid and a first mixture;

(c) a digester for anaerobically treating the first mixture to provide a second mixture;

(d) a second conduit intermediate the first solids separator and the digester for conducting the first mixture from the first solids separator to the digester;

(e) a second solids separator;

(f) a third conduit intermediate the digester and the second solids separator for conducting the second mixture to the second solids separator;

(g) a fourth conduit intermediate the first solids separator and the second solids separator for conducting the first liquid to the second solids separator;

(h) an inorganic phosphorus reactor for making inorganic phosphorus; and

(i) a fifth conduit intermediate the second solids separator and the inorganic phosphorus reactor.

In certain embodiments, the third conduit joins the fourth conduit to combine the first liquid with the second mixture prior to their introduction to the second solids separator.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIG. 1 is a schematic illustration of a representative method of the invention for treating wastewater and producing inorganic phosphorus.

FIG. 2 is a schematic illustration of a representative method of the invention for treating wastewater and producing inorganic phosphorus.

FIG. 3 is a schematic illustration of a representative system of the invention for treating wastewater and producing inorganic phosphorus.

FIG. 4 is a schematic illustration of a representative system of the invention for treating wastewater and producing inorganic phosphorus.

### DETAILED DESCRIPTION OF THE INVENTION

The invention provides methods and systems for removing and recovering of phosphorus from wastewater through the formation of inorganic phosphorus (e.g., struvite). The methods and systems advantageously remove phosphorus from wastewater treatment streams and provide inorganic phosphorus as a valuable byproduct.

As noted above, in a typical wastewater treatment process, waste activated sludge is conducted to a solids separation for thickening, where the liquids are tapped off and returned to the wastewater plant for treatment and the resultant thickened sludge is conducted to an anaerobic digester with other sludge where it remains for a period of time before being conducted to a second solids separation. The liquid from the solids separation step is further processed and the solids, often referred to as biosolids, are removed from the process stream and disposed of. However, biosolids separated from process streams through solids separation steps can contain significant and useful quantities of phosphorus.

The present invention addresses the problem of phosphorus-containing biosolids. The methods and systems of the invention effectively reduce the amount of phosphorus in the biosolids and furthermore increase the amount of the valuable inorganic phosphorus produced.

The methods and systems of the invention accomplish these benefits by capturing phosphorus from the anaerobic digestion step. In conventional methods, the product of anaerobic digestion is subject to solids separation, which provides an ammonia-rich, phosphorus- and magnesium-reduced mixture. Solid separation provides phosphorus-containing biosolids and an ammonia-rich, phosphorus- and magnesium-reduced liquid and biosolids. Because the pH of the mixture produced from anaerobic digestion is moderately alkaline, conditions under which phosphorus is not very soluble, the biosolids are rich in phosphorus.

In the practice of the invention, the moderately alkaline ammonia-rich, phosphorus- and magnesium-reduced mixture is combined with the more acidic phosphorus- and magnesium-rich liquid produced in the initial solids separation step. The effect of combining the two process streams is to lower the pH of the product of the anaerobic digestion step thereby increasing the solubility of phosphorus in the combined stream. The resulting increase in phosphorus solubility provides the two-fold advantage of increasing the amount of phosphorus available for inorganic phosphorus formation and reducing the amount of phosphorus in bio solids, which are conducted from the system.

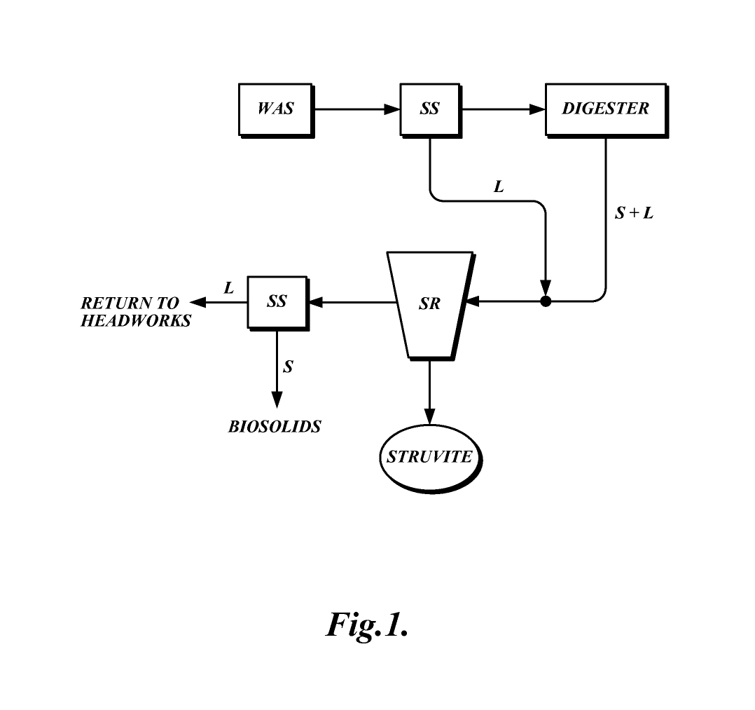

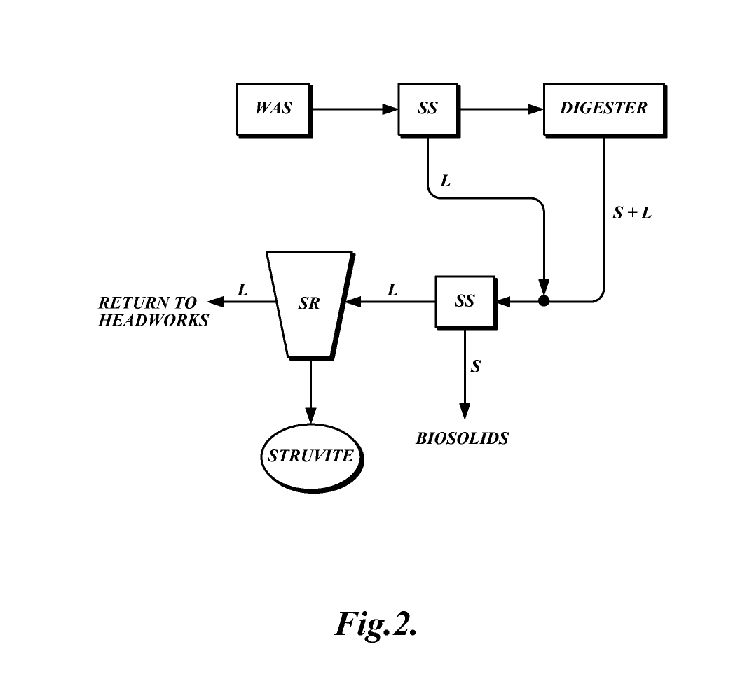

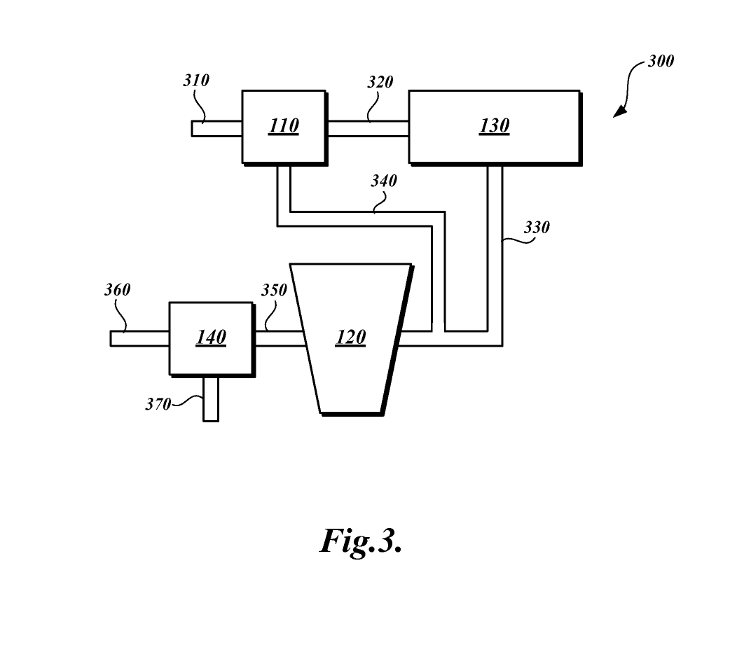

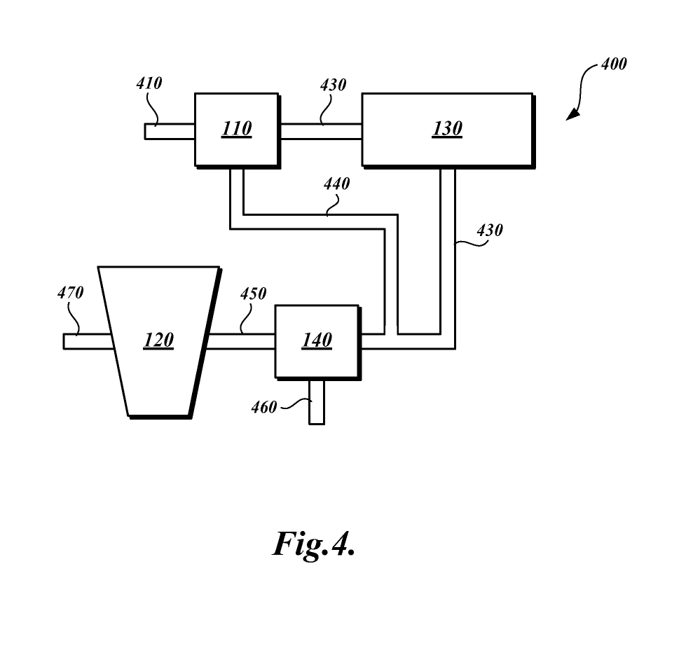

Schematic illustrations of representative methods of the invention for treating wastewater and producing inorganic phosphorus are shown in FIGS. 1 and 2. Schematic illustrations of representative systems of the invention for treating wastewater and producing inorganic phosphorus are shown in FIGS. 3 and 4.

Referring to FIG. 1, a mixture of microorganisms containing phosphorus and magnesium are induced to release phosphorus and magnesium into liquid to provide a treated mixture that includes phosphorus and magnesium (waste-activated sludge, WAS). The treated mixture is then separated into a phosphorus- and magnesium-rich liquid (liquid, L) and a phosphorus- and magnesium-reduced mixture in a solids separation step.

The phosphorus- and magnesium-reduced mixture is subjected to anaerobic digestion, where ammonia is released, to provide an ammonia-rich, phosphorus- and magnesium-reduced mixture containing suspended solids in liquid (S+L). At this point substantially no combination of phosphorus and magnesium occurs because of the relatively low concentration of each.

The phosphorus- and magnesium-rich liquid (L) is combined with the ammonia-rich, phosphorus- and magnesium-reduced mixture (S+L) and conducted to an inorganic phosphorus reactor (struvite reactor, SR) where inorganic phosphorus is formed. There, magnesium is optionally added, if necessary, and pH is optionally adjusted (e.g., addition of sodium hydroxide or other suitable pH booster), if necessary, to provide inorganic phosphorus. The inorganic phosphorus (e.g., struvite) is collected from the reactor.

Residual solids-containing liquid from the reactor is optionally subjected to solids separation to provide biosolids and a liquid optionally conducted to the process headworks. Solids separation can be achieved by a variety of conventional means including gravity belts, filters, and centrifuges. The biosolids are removed from the system.

Thus, in one embodiment, the method includes the following steps:

(a) inducing a mixture of microorganisms containing phosphorus and magnesium to release phosphorus and magnesium to provide a treated mixture that includes phosphorus and magnesium;

(b) separating the treated mixture into a phosphorus- and magnesium-rich liquid and a phosphorus- and magnesium-reduced mixture;

(c) anaerobically treating the phosphorus- and magnesium-reduced mixture to provide an ammonia-rich, phosphorus- and magnesium-reduced mixture;

(d) combining the phosphorus- and magnesium-rich liquid from step (b) with the ammonia-rich, phosphorus- and magnesium-reduced mixture from step (c) to provide an ammonia-, phosphorus-, and magnesium-containing mixture; and

(e) conducting the ammonia-, phosphorus-, and magnesium-containing mixture to an inorganic phosphorus reactor to provide inorganic phosphorus.

In one embodiment, residual solids-containing liquid from the reactor is subjected to solids separation to provide biosolids and a liquid optionally conducted to the process headworks.

In one embodiment, magnesium and pH boosters are optionally added to the reactor to provide inorganic phosphorus.

A second embodiment of the method of the invention is illustrated in FIG. 2. Referring to FIG. 2, a mixture of microorganisms containing phosphorus and magnesium are induced to release phosphorus and magnesium into liquid to provide a treated mixture that includes phosphorus and magnesium (waste-activated sludge, WAS). The treated mixture is then separated into a phosphorus- and magnesium-rich liquid (liquid, L) and a phosphorus- and magnesium-reduced mixture in a solids separation step.

The phosphorus- and magnesium-reduced mixture is subjected to anaerobic digestion, where ammonia is released, to provide an ammonia-rich, phosphorus- and magnesium-reduced mixture containing suspended solids in liquid (S+L). At this point substantially no combination of phosphorus and magnesium occurs because of the relatively low concentration of each.

The phosphorus- and magnesium-rich liquid (L) is combined with the ammonia-rich, phosphorus- and magnesium-reduced mixture (S+L) to provide an ammonia-, phosphorus-, and magnesium-containing mixture that is subjected to solids separation to provide an ammonia-, phosphorus-, and magnesium-containing liquid (L) and biosolids (S). Solids separation can be achieved by a variety of conventional means including gravity belts, filters, and centrifuges. The biosolids are removed from the system.

The ammonia-, phosphorus-, and magnesium-containing liquid (L) is conducted to an inorganic phosphorus reactor to provide inorganic phosphorus (struvite reactor, SR) where inorganic phosphorus is formed. There, magnesium is optionally added, if necessary, and pH is optionally adjusted (e.g., addition of sodium hydroxide or other suitable pH booster), if necessary, to provide inorganic phosphorus. The inorganic phosphorus (e.g., struvite) is collected from the reactor. Liquid from the reactor is optionally conducted to the process headworks.

Thus, in one embodiment, the method includes the following steps:

(a) inducing a mixture of microorganisms containing phosphorus and magnesium to release phosphorus and magnesium to provide a treated mixture that includes phosphorus and magnesium;

(b) separating the treated mixture into a phosphorus- and magnesium-rich liquid and a phosphorus- and magnesium-reduced mixture;

(c) anaerobically treating the phosphorus- and magnesium-reduced mixture to provide an ammonia-rich, phosphorus- and magnesium-reduced mixture;

(d) combining the phosphorus- and magnesium-rich liquid from step (b) with the ammonia-rich, phosphorus- and magnesium-reduced mixture from step (c) to provide an ammonia-, phosphorus-, and magnesium-containing mixture;

(e) subjecting the ammonia-, phosphorus-, and magnesium-containing mixture to solids separation to provide an ammonia-, phosphorus-, and magnesium-containing liquid and biosolids; and

(f) conducting the ammonia-, phosphorus-, and magnesium-containing liquid to an inorganic phosphorus reactor to provide inorganic phosphorus.

In one embodiment, liquid from the reactor is conducted to the process headworks.

In one embodiment, magnesium and pH boosters are optionally added to the reactor to provide inorganic phosphorus.

In another aspect, the invention provides systems for treating wastewater and producing inorganic phosphorus are provided. The systems are effective in carrying out the methods of the invention. In the systems, the moderately alkaline (e.g., pH about 8) ammonia-rich, phosphorus- and magnesium reduced mixture produced from anaerobic digestion is combined with the more acidic (e.g., pH about 5 to about 7) phosphorus- and magnesium-rich liquid produced from the first solids separation to provide an ammonia-, phosphorus-, and magnesium-containing mixture that is conducted to an inorganic phosphorus reactor, either before or after further solids separation.

A representative system of the invention is illustrated schematically in FIG. 3. Referring to FIG. 3, system 300 comprises:

(a) a first conduit 310 for introducing a material into a first solids separator 110;

(b) a first solids separator 110 for separating the material into a first liquid and a first mixture;

(c) a digester 130 for anaerobically treating the first mixture to provide a second mixture;

(d) a second conduit 320 intermediate the first solids separator 110 and the digester 130 for conducting the first mixture from the first solids separator to the digester;

(e) an inorganic phosphorus reactor 120 for making inorganic phosphorus;

(f) a third conduit 330 intermediate the digester 130 and the inorganic phosphorus reactor 120 for conducting the second mixture to the inorganic phosphorus reactor;

(g) a fourth conduit 340 intermediate the first solids separator 110 and the inorganic phosphorus reactor 120 for conducting the first liquid to the inorganic phosphorus reactor;

(h) a second solids separator 140; and

(i) a fifth conduit 350 intermediate the inorganic phosphorus reactor 120 and the second solids separator 140.

In the method, the third conduit 330 joins the fourth conduit 340 to combine the first liquid with the second mixture prior to their introduction to the inorganic phosphorus reactor 120.

A second representative system of the invention is illustrated schematically in FIG. 4. Referring to FIG. 4, system 400 comprises:

(a) a first conduit 410 for introducing a material into a first solids separator 110;

(b) a first solids separator 110 for separating the material into a first liquid and a first mixture;

(c) a digester 130 for anaerobically treating the first mixture to provide a second mixture;

(d) a second conduit 420 intermediate the first solids separator 110 and the digester 130 for conducting the first mixture from the first solids separator to the digester;

(e) a second solids separator 140;

(f) a third conduit 430 intermediate the digester 130 and the second solids separator 140 for conducting the second mixture to the second solids separator;

(g) a fourth conduit 440 intermediate the first solids separator 110 and the second solids separator 140 for conducting the first liquid to the second solids separator;

(h) an inorganic phosphorus reactor 120 for making inorganic phosphorus; and

(i) a fifth conduit 450 intermediate the second solids separator 140 and the inorganic phosphorus reactor 120.

In the method, the third conduit 430 joins the fourth conduit 440 to combine the first liquid with the second mixture prior to their introduction to the second solids separator.

In the methods and systems described herein, it will be appreciated that the inlet ends of conduits can connect either to a source conduit or to the system component (e.g., digester) from which the source conduit is flowing, and that the outlet ends of conduits can connect either to a destination conduit or to the system into which the destination conduit flows. As described herein, when one configuration is stated (e.g., a conduit connecting on its inlet end to a source conduit) it is also intended that it include the other (that same conduit connecting on its inlet end to the equipment from which the specified source conduit is flowing).

In the methods and systems of the invention, ammonia is combined with phosphorus and magnesium to produce inorganic phosphorus (e.g., struvite). It will be appreciated that the nature of the ammonia will depend on the pH of the environment of the process streams in which the ammonia is present. For example, at lower pH, ammonia will be in the form of ammonium (NH₄⁺) and can be associated with counterions (e.g., sulfate, SO₄²⁻).

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for treating wastewater and producing inorganic phosphorus, comprising:
(a) inducing a mixture of microorganisms containing phosphorus and magnesium to release phosphorus and magnesium to provide a treated mixture that includes phosphorus and magnesium;
(b) separating the treated mixture into a phosphorus- and magnesium-rich liquid and a first phosphorus- and magnesium-reduced mixture;
(c) anaerobically treating the first phosphorus- and magnesium-reduced mixture to provide an ammonia-rich, phosphorus- and magnesium-reduced mixture;
(d) combining the phosphorus- and magnesium-rich liquid from step (b) with the ammonia-rich, phosphorus- and magnesium-reduced mixture from step (c) to provide an ammonia-, phosphorus-, and magnesium-containing product; and
(e) conducting the ammonia-, phosphorus-, and magnesium-containing product to an inorganic phosphorus reactor to provide inorganic phosphorus and a phosphorus- and magnesium-containing mixture.

2. The method of claim 1 further comprising subjecting the phosphorus- and magnesium-containing mixture to solids separation to provide biosolids and a phosphorus- and magnesium-reduced liquid.

3. The method of claim 1 further comprising subjecting the ammonia-, phosphorus-, and magnesium-containing product to solids separation to provide biosolids and an ammonia-, phosphorus-, and magnesium-containing liquid, and conducting the ammonia-, phosphorus-, and magnesium-containing liquid to the inorganic phosphorus reactor.

4. A method for treating wastewater and producing inorganic phosphorus, comprising:
(a) inducing a mixture of microorganisms containing phosphorus and magnesium to release phosphorus and magnesium to provide a treated mixture that includes phosphorus and magnesium;
(b) separating the treated mixture into a phosphorus- and magnesium-rich liquid and a phosphorus- and magnesium-reduced mixture;
(c) anaerobically treating the phosphorus- and magnesium-reduced mixture to provide an ammonia-rich, phosphorus- and magnesium-reduced mixture;
(d) combining the phosphorus- and magnesium-rich liquid from step (b) with the ammonia-rich, phosphorus- and magnesium-reduced mixture from step (c) to provide an ammonia-, phosphorus-, and magnesium-containing mixture; and
(e) conducting the ammonia-, phosphorus-, and magnesium-containing mixture to an inorganic phosphorus reactor to provide inorganic phosphorus.

5. The method of claim 4 further comprising subjecting residual solids-containing liquid from the reactor to solids separation to provide biosolids and a liquid optionally conducted to the process headworks.

6. The method of claim 4 further comprising adjusting the pH of the contents of the inorganic phosphorus reactor.

7. The method of claim 4 further comprising adding magnesium to the contents of the inorganic phosphorus reactor.

8. The method of claim 4, wherein the inorganic phosphorus is a magnesium ammonium phosphate hexahydrate.

9. A method for treating wastewater and producing inorganic phosphorus, comprising:
(a) inducing a mixture of microorganisms containing phosphorus and magnesium to release phosphorus and magnesium to provide a treated mixture that includes phosphorus and magnesium;
(b) separating the treated mixture into a phosphorus- and magnesium-rich liquid and a phosphorus- and magnesium-reduced mixture;
(c) anaerobically treating the phosphorus- and magnesium-reduced mixture to provide an ammonia-rich, phosphorus- and magnesium-reduced mixture;
(d) combining the phosphorus- and magnesium-rich liquid from step (b) with the ammonia-rich, phosphorus- and magnesium-reduced mixture from step (c) to provide an ammonia-, phosphorus-, and magnesium-containing mixture;
(e) subjecting the ammonia-, phosphorus-, and magnesium-containing mixture to solids separation to provide an ammonia-, phosphorus-, and magnesium-containing liquid and biosolids; and
(f) conducting the ammonia-, phosphorus-, and magnesium-containing liquid to an inorganic phosphorus reactor to provide inorganic phosphorus.

10. The method of claim 9 further comprising conducting liquid from the reactor to the process headworks.

11. The method of claim 9 further comprising adjusting the pH of the contents of the inorganic phosphorus reactor.

12. The method of claim 9 further comprising adding magnesium to the contents of the inorganic phosphorus reactor.

13. The method of claim 9, wherein the inorganic phosphorus is a magnesium ammonium phosphate hexahydrate.

14. A system for producing inorganic phosphorus from wastewater, comprising:
(a) a first conduit for introducing a material into a first solids separator;
(b) a first solids separator for separating the material into a first liquid and a first mixture;
(c) a digester for anaerobically treating the first mixture to provide a second mixture;
(d) a second conduit intermediate the first solids separator and the digester for conducting the first mixture from the first solids separator to the digester;
(e) an inorganic phosphorus reactor for making inorganic phosphorus;
(f) a third conduit intermediate the digester and the inorganic phosphorus reactor for conducting the second mixture to the inorganic phosphorus reactor;
(g) a fourth conduit intermediate the first solids separator and the inorganic phosphorus reactor for conducting the first liquid to the inorganic phosphorus reactor;
(h) a second solids separator; and
(i) a fifth conduit intermediate the inorganic phosphorus reactor and the second solids separator.

15. The system of claim 14, wherein the third conduit joins the fourth conduit to combine the first liquid with the second mixture prior to their introduction to the inorganic phosphorus reactor.

16. A system for producing inorganic phosphorus from wastewater, comprising:
(a) a first conduit for introducing a material into a first solids separator;
(b) a first solids separator for separating the material into a first liquid and a first mixture;
(c) a digester for anaerobically treating the first mixture to provide a second mixture;
(d) a second conduit intermediate the first solids separator and the digester for conducting the first mixture from the first solids separator to the digester;
(e) a second solids separator;
(f) a third conduit intermediate the digester and the second solids separator for conducting the second mixture to the second solids separator;
(g) a fourth conduit intermediate the first solids separator and the second solids separator for conducting the first liquid to the second solids separator;
(h) an inorganic phosphorus reactor for making inorganic phosphorus; and
(i) a fifth conduit intermediate the second solids separator and the inorganic phosphorus reactor.

17. The system of claim 16, wherein the third conduit joins the fourth conduit to combine the first liquid with the second mixture prior to their introduction to the second solids separator.
